(19) United States
(12) Patent Application Publication
(10) Pub. No.: US 2014/0205194 A1
(43) Pub. Date: Jul. 24, 2014

(54) INFORMATION PROCESSING APPARATUS AND COMPUTER-READABLE MEDIUM

(71) Applicant: FUJI XEROX CO., LTD., TOKYO (JP)

(72) Inventors: Shinpei NODA, Kanagawa (JP); Yuichi ONEDA, Kanagawa (JP); Kenichiro FUKUDA, Kanagawa (JP)

(73) Assignee: FUJI XEROX CO., LTD., TOKYO (JP)

(21) Appl. No.: 13/973,223

(22) Filed: Aug. 22, 2013

(30) Foreign Application Priority Data
Jan. 23, 2013 (JP) 2013-010400

(51) Int. Cl. G06K 9/62

(52) U.S. Cl. CPC G06K 9/6202
USPC 382/190

(57) ABSTRACT

An information processing apparatus includes a feature extraction unit, and a storage unit. The feature extraction unit extracts an extracted feature value indicating a characteristic of a target image, from a feature extraction area set by a user. The storage unit stores the extracted feature value in a database and includes a determination unit, a second storage unit, and a notification unit. The determination unit calculates a degree of similarity to the extracted feature value for each feature value in the database, and determines whether a feature value whose degree of similarity to the extracted feature value is a certain value or more is stored in the database. The second storage unit stores the extracted feature value in the database when the determination result is negative. The notification unit outputs a predetermined notification to the user without storing the extracted feature value, when the determination result is positive.

### CROSS-REFERENCE TO RELATED APPLICATIONS

This application is based on and claims priority under 35 USC 119 from Japanese Patent Application No. 2013-010400 filed Jan. 23, 2013.

### BACKGROUND

1. Technical Field

The present invention relates to an information processing apparatus and a computer-readable medium.

2. Summary

According to an aspect of the present invention, there is provided an information processing apparatus including a feature extraction unit, and a storage unit. The feature extraction unit extracts an extracted feature value indicating a characteristic of a target image, from a feature extraction area which has been set by a user. The storage unit stores the extracted feature value extracted by the feature extraction unit in a database. The storage unit includes a determination unit, a second storage unit, and a notification unit. The determination unit calculates a degree of similarity to the extracted feature value extracted by the feature extraction unit, for each of feature values stored in the database, and determines whether or not a feature value whose degree of similarity to the extracted feature value extracted by the feature extraction unit is equal to or more than a certain value is stored in the database. The second storage unit stores the extracted feature value extracted by the feature extraction unit in the database when it is determined that a feature value whose degree of similarity to the extracted feature value extracted by the feature extraction unit is equal to or more than the certain value is not stored in the database. The notification unit outputs predetermined notification information to the user without storing the extracted feature value extracted by the feature extraction unit in the database, when it is determined that a feature value whose degree of similarity to the extracted feature value extracted by the feature extraction unit is equal to or more than the certain value is stored in the database.

### BRIEF DESCRIPTION OF THE DRAWINGS

Exemplary embodiments of the present invention will be described in detail based on the following figures, wherein:

FIG. 1 is a diagram illustrating the configuration of a server;

FIG. 2 is a diagram illustrating an exemplary document;

FIG. 3 is a flowchart of a process performed by the server;

FIG. 4 is a diagram illustrating an exemplary image with a marker;

FIG. 5 is a diagram illustrating an exemplary storage in a database;

FIG. 6 is a flowchart of a process performed by the server;

FIG. 7A is a diagram illustrating a storage routine; and

FIG. 7B is a diagram illustrating the storage routine.

### DETAILED DESCRIPTION

An exemplary embodiment of the present invention will be described in detail below on the basis of the drawings.

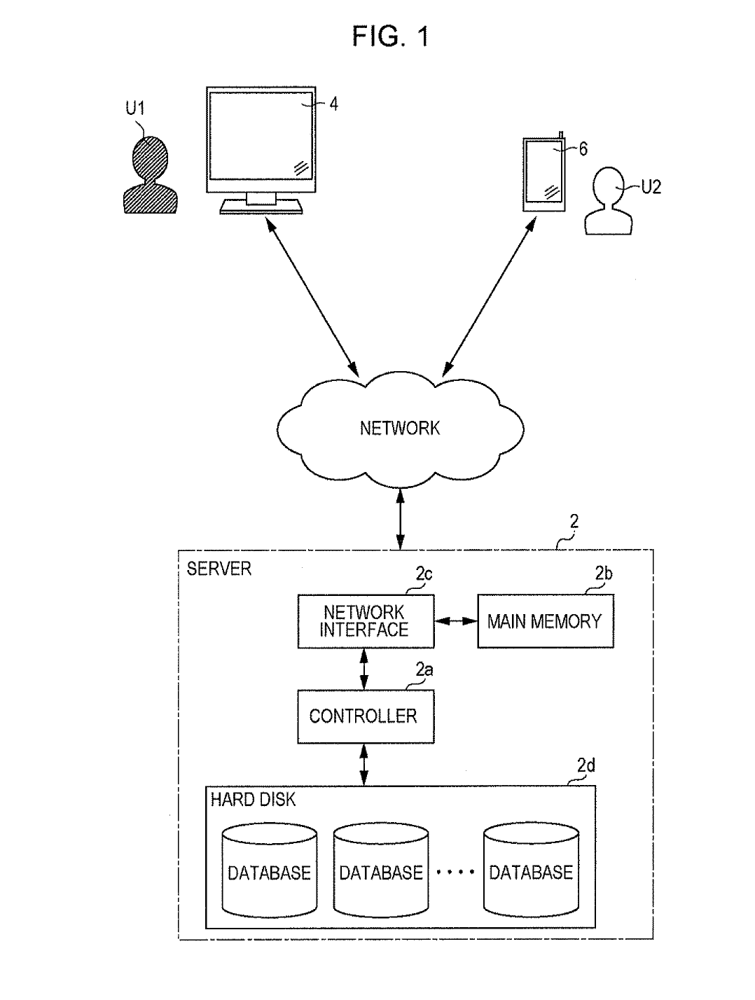

FIG. 1 is a diagram illustrating the configuration of an information processing apparatus according to the exemplary embodiment of the present invention. In the present exemplary embodiment, the information processing apparatus is embodied as a server 2 including a controller 2a, a main memory 2b, a network interface 2c, and a hard disk 2d. The controller 2a is a microprocessor, and performs various types of information processing in accordance with programs stored in the main memory 2b. The main memory 2b includes a read-only memory (ROM) and a random-access memory (RAM), and stores the above-described programs. The programs are read out from a computer-readable information storage medium such as a digital versatile disk (DVD™)-ROM, and are stored in the main memory 2b. The programs may be downloaded via a network, and may be stored in the main memory 2b.

The main memory 2b stores information necessary for various types of information processing, and serves also as a work memory.

The network interface 2c is an interface for connecting the server 2 to a network. The network interface 2c is used to receive/transmit information from/to the network in accordance with instructions from the controller 2a. As illustrated in FIG. 1, a working information terminal 4 for a user U1 and a portable terminal 6 for a user U2 are connected to the network, and are capable of communicating with the server 2 via the network.

Actually, any number of working information terminals 4 for respective users U1 are connected to the network. FIG. 1 illustrates one of the working information terminals 4 for the users U1. In this example, the user U1 using the working information terminal 4 illustrated in FIG. 1 is a worker for a manufacturer. In addition, a free application provided by the manufacturer is installed in the portable terminal 6.

The hard disk 2d stores various types of information. In the present exemplary embodiment, the hard disk 2d stores multiple databases. The data stored in the databases will be described below.

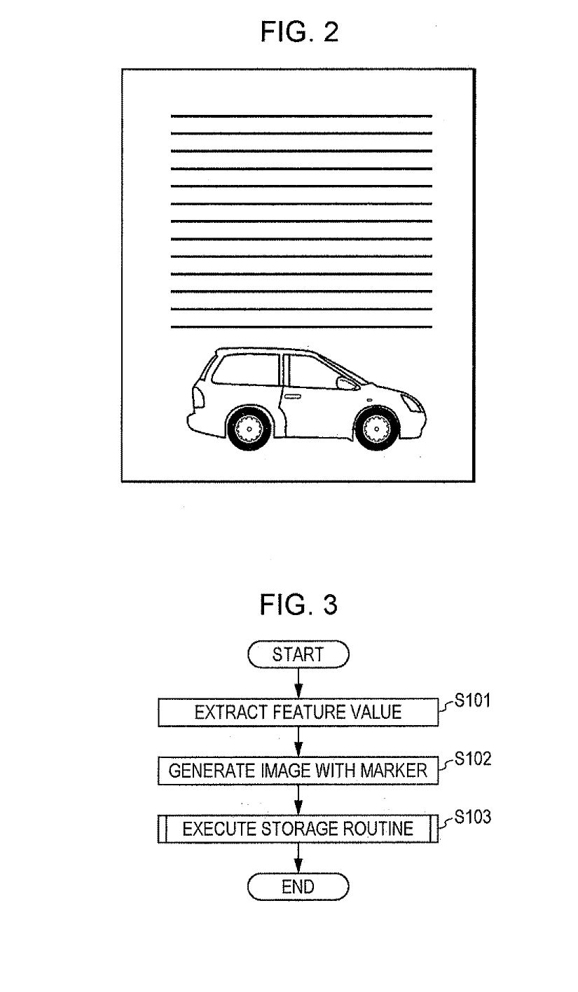

The server 2 is provided with a web server function, and provides a web application. The user U1 accesses the server 2 by using a browser implemented in the working information terminal 4, and uses the web application. The user U1 uses the web application to upload document data indicating a document, for example, a pamphlet, which is created for advertisement of a product of the manufacturer, to the server 2. FIG. 2 illustrates an exemplary document.

When the document data is uploaded, an image of the document indicated by the uploaded document data (hereinafter, referred to as a target image) is displayed in the browser. The user U1 selects a desired database (for example, a database related to the product), and then sets a feature-extraction target area in the target image while referring to the target image displayed in the browser. For example, the user U1 sets an area to which attention is to be given (for example, a surrounding area of the image of the product of the manufacturer) as a feature-extraction target area. The user U1 not only sets a feature-extraction target area, but also inputs a uniform resource locator (URL) for content about a display component in the feature-extraction target area. For example, the user U1 inputs a URL for movie content for viewing a state in which the product of the manufacturer is operating. Thus, the user U1 associates the display component in the feature-extraction target area with the content. The content corresponds to an “information resource”, and the URL corresponds to “address information”.

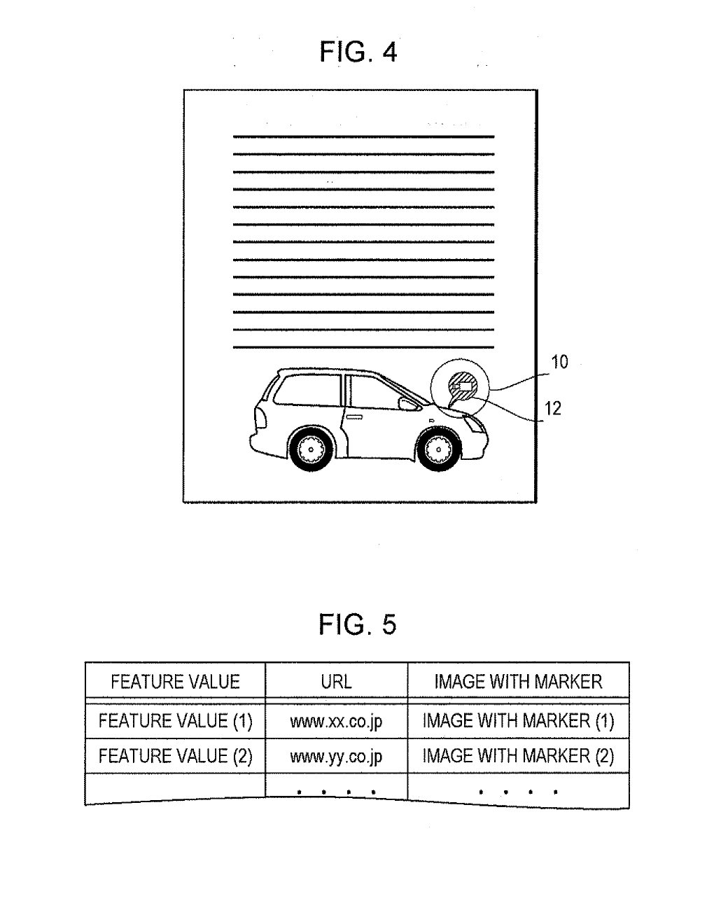

In the present exemplary embodiment, the user U1 specifies a position at which a marker 10 (see FIG. 4 described below) which is a ring of a concentric circle having a radius of a predetermined length is to be disposed, in the target image. By doing this, the user U1 sets the area in the circumscribed rectangle of the marker 10 as a feature-extraction target area.

The data for identifying the database selected by the user U1 (hereinafter, referred to as a database Y), the data for specifying the feature-extraction target area which has been set by the user U1, and the URL which has been input by the user U1 are transmitted to the server 2. In the server 2 receiving these, the controller 2a performs the process illustrated in FIG. 3.

That is, the controller 2a (feature extraction unit) specifies the feature-extraction target area on the basis of the data received from the working information terminal 4 for the user U1, and extracts a feature value indicating characteristics of the target image, from the feature-extraction target area (in step S101). In the present exemplary embodiment, in step S101, the controller 2a extracts one or more feature points of the target image from the feature-extraction target area, as a feature value in accordance with the scale-invariant feature transform (SIFT) algorithm.

In addition, the controller 2a generates an image with a marker, in which the marker 10 is disposed in the target image, on the basis or the data received from the working information terminal 4 for the user U1 (in step S102). FIG. 4 illustrates an exemplary image with a marker. As illustrated in FIG. 4, the image with a marker includes the marker 10. The marker 10 is disposed at the position specified by the user U1. In addition, the image with a marker also includes an anchor image 12 in the area surrounded by the marker 10. The anchor image 12 indicates the type of content of the link indicated by the URL which has been input by the user U1. The anchor image 12 illustrated in FIG. 4 indicates movie content. The marker 10 and the anchor image 12 both are semitransparent images.

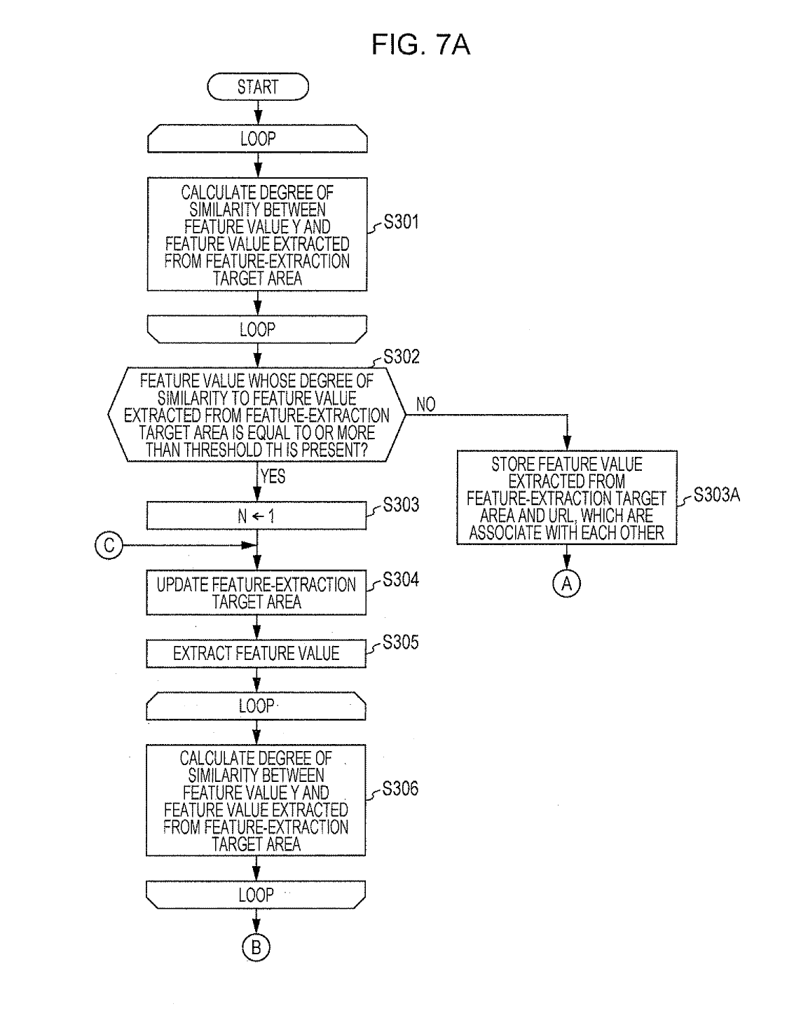

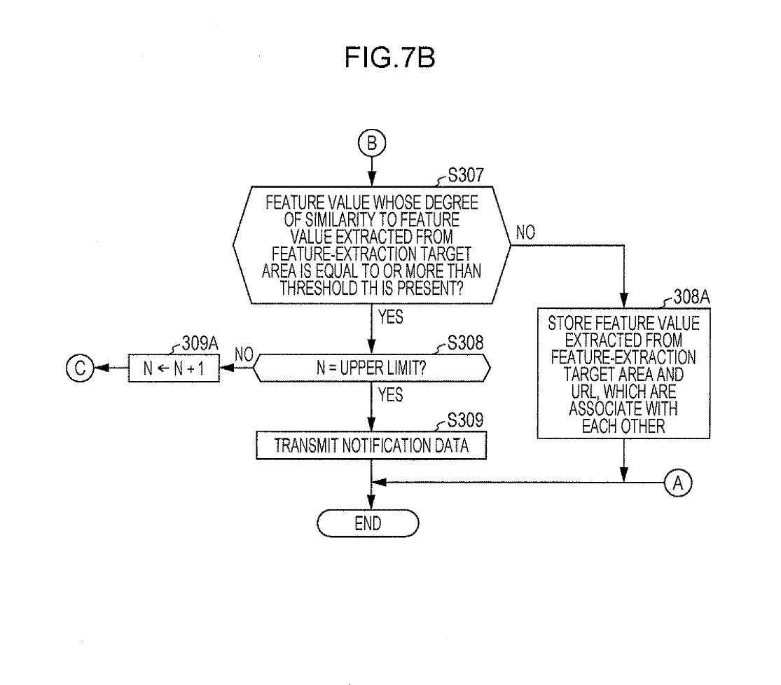

The controller 2a (storage unit) specifies a database Y on the basis of the data received from the working information terminal 4 for the user U1, and then executes a storage routine (in step S103). The detail will be described below. In short, in step S103, the controller 2a basically associates the feature value extracted in step S101, the URL which has been input by the user U1, and the image with a marker which is generated in step S102 with each other so as to store them in the database Y (see step S303A in FIG. 7A described below). That is, in step S103, the controller 2a stores a record in which the feature value extracted in step S101, the URL which has been input by the user U1, and the image with a marker generated in step S102 are associated with each other, in the hard disk 2d in such a manner that the record is associated with the database name of the database Y. A database name is also called a folder name. FIG. 5 illustrates an exemplary storage in a certain database. FIG. 5 illustrates records with which the database name of the certain database is associated. A database name corresponds to identification information of a feature value group containing feature values associated with the database name. In other words, one database stores one feature value group. Therefore, in other words, the process in step S103 is a process of adding the feature value extracted in step S101 into the feature value group stored in the database Y.

A large number of copies of the image with a marker are printed as pamphlets for advertising the product of the manufacturer. The printed pamphlets are distributed to any number of persons.

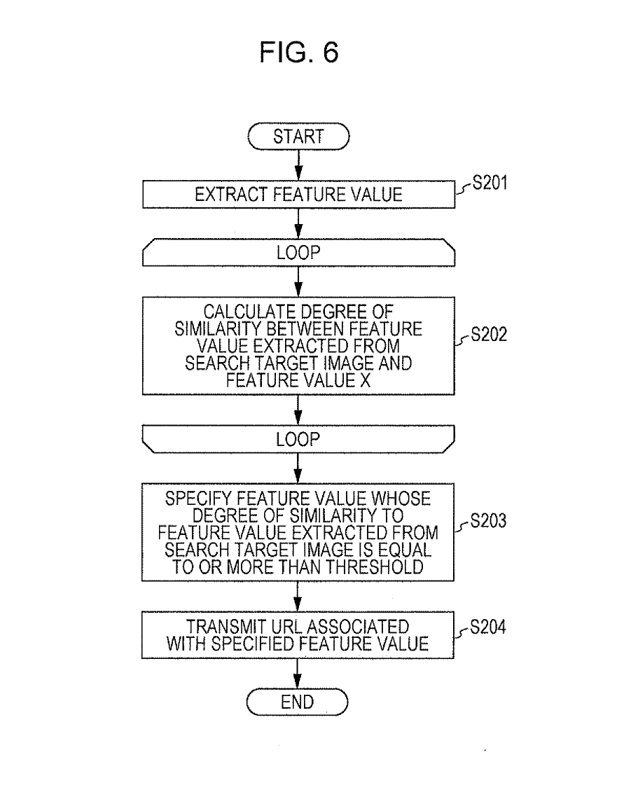

In the server 2, an idea for efficiently advertising a product to the user U2 obtaining a pamphlet is implemented. That is, the user U2 focuses the digital camera included in the portable terminal 6 (second information processing apparatus) on the marker 10, and photographs an area including the marker 10, so that the content associated with the display component (for example, a product) in the area is automatically displayed on the portable terminal 6. Specifically, the user U2 selects a database specified in the pamphlet, and then photographs an area including the marker 10. Then, the above-described application is used to cut out an image of the circumscribed rectangle area of the marker 10 as a search target image from the photographed image captured by using the digital camera, and data for identifying the database selected by the user U2 and data indicating the search target image are transmitted to the server 2. Receiving these pieces of data, the server 2 performs the process illustrated in FIG. 6.

The process illustrated in FIG. 6 will be described below. A database selected by the user U2 is referred to as a database X. In other words, a database X is a feature value group selected by the user U2.

The controller 2a extracts a feature value indicating characteristics of the search target image (in step S201).

In the present exemplary embodiment, in step S201, the controller 2a extracts one or more feature points as a feature value from the search target image in accordance with the SIFT algorithm.

Then, the controller 2a (search unit) searches for a feature value whose degree of similarity to the feature value extracted from the search target image is equal to or more than a predetermined threshold TH, from feature values stored in the database X in steps S202 and S203.

That is, the controller 2a (search unit) sequentially selects feature values stored in the database X, that is, feature values associated with the database name of the database X, one by one as a feature value X, and calculates a degree of similarity between the feature value extracted from the search target image and a feature value X every time the feature value X is selected (in step S202). In the present exemplary embodiment, in step S202, the controller 2a compares the feature points extracted from the search target image with the feature points indicated by a feature value X, and calculates the number of combinations of feature points between which a correspondence is present, as a degree of similarity.

In step S203, the controller 2a (search unit) specifies feature values whose degrees of similarity to the feature value extracted from the search target image are equal to or more than the threshold TH, from the feature values stored in the database X on the basis of the degree of similarity calculated in step S202 (in step S203).

Then, the controller 2a (transmitting unit) transmits the URL which is stored in the database X in such a manner that the URL is associated with a feature value specified in step S203, to the portable terminal 6 (in step S204). In the exemplary embodiment, the controller 2a transmits the URL associated with the feature value whose degree of similarity to the feature value extracted from the search target image is maximum among the feature values specified in step S203, to the portable terminal 6. In the portable terminal 6 which receives the URL, the content of the link indicated by the URL is obtained, and the obtained content is output. As a result, the user U2 views, for example, the movie showing a state in which the product described in the pamphlet actually operates.

In the case where the feature values for images similar to each other are stored in the same database, that is, in the case where the feature values for images similar to each other belong to the same feature value group, when the process illustrated in FIG. 6 is performed, content different from that to be output may be output. In this regard, the server 2 is configured in such a manner that the storage routine causes the feature values for images similar to each other to be prevented from being stored in the same database. That is, the storage routine causes the feature values for images similar to each other to be prevented from belonging to the same feature value group. The storage routine will be described below with reference to FIGS. 7A and 7B illustrating the storage routine.

In the storage routine, the controller 2a sequentially selects the feature values stored in the database Y which is a database selected by the user U1, that is, the feature values associated with the database name of the database Y, one by one as a feature value Y. Every time the controller 2a selects a feature value Y, the controller 2a calculates a degree of similarity between the feature value Y and the feature value extracted from the feature-extraction target area in step S101, as in step S202 in FIG. 6 (in step S301).

The controller 2a (determination unit) determines whether or not a feature value whose degree of similarity to the feature value extracted from the feature-extraction target area is equal to or more than the above-described threshold TH is present in the database Y, on the basis of the degree of similarity calculated in step S301 (in step S302). If a feature value whose degree of similarity to the feature value extracted from the feature-extraction target area is equal to or more than the above-described threshold TH is not present (NO in step S302), the controller 2a associates the feature value extracted from the feature-extraction target area in step S101, the URL which has been input by the user U1, and the image with a marker generated in step S102 with each other, and stores them in the database Y (in step S303A). Then the storage routine is ended.

If a feature value whose degree of similarity to the feature value extracted from the feature-extraction target area is equal to or more than the above-described threshold TH is present (YES in step S302), the controller 2a sets the number of updates ‘N’ to ‘1’ (in step S303). In addition, the controller 2a (update unit) updates the feature-extraction target area (in step S304). Herein, in step S304, the controller 2a enlarges the feature-extraction target area by using a predetermined scale of enlargement. In step S304, the controller 2a may move the feature-extraction target area by a predetermined distance.

Unless otherwise specified below, a “feature-extraction target area” means an “updated feature-extraction target area”. An “initial feature-extraction target area” means a “feature-extraction target area which is set by the user U1”.

Then, the controller 2a (re-extraction unit) extracts a feature value indicating the characteristics of the target image, from the feature-extraction target area, as in step S101 in FIG. 3 (in step S305).

As in step S301, the controller 2a sequentially selects the feature values stored in the database Y, one by one as a feature value Y. Every time the controller 2a selects a feature value Y, the controller 2a calculates a degree of similarity between the feature value Y and the feature value extracted from the feature-extraction target area in step S305 (in step S306).

As in step S302, the controller 2a (redetermination unit) determines whether or not a feature value whose degree of similarity to the feature value extracted from the feature-extraction target area in step S305 is equal to or more than the above-described threshold TH is present in the database Y (in step S307). If a feature value whose degree of similarity to the feature value extracted from the feature-extraction target area is equal to or more than the above-described threshold TH is not present (NO in step S307), the controller 2a performs the following processes. Since the feature-extraction target area is enlarged from the initial area, the controller 2a generates again an image with a marker by disposing the anchor image 12 and the marker 10 which is a ring of an inscribed circle in the feature-extraction target area, in the target image. Then, the controller 2a associates the feature value extracted from the feature-extraction target area in step S305, the URL which has been input by the user U1, and the image with a marker generated again, and stores them in the database Y (in step S308A). Then, the storage routine is ended.

If a feature value whose degree of similarity to the feature value extracted from the feature-extraction target area in step S305 is equal to or more than the above-described threshold TH is present (YES in step S307), the controller 2a determines whether or not the number of updates ‘N’ is equal to an upper limit, for example, ‘5’ (in step S308). If the number of updates ‘N’ is less than the upper limit (NO in step S308), the controller 2a increments the number of updates ‘N’ by ‘1’ (in step S309A), and performs step S304 and its subsequent steps again.

If the number of updates ‘N’ is equal to the upper limit (YES in step S308), without storing the feature value extracted from the feature-extraction target area in step S305, the controller 2a (notification unit) transmits predetermined notification data to the working information terminal 4 for the user U1 (in step S309). In the working information terminal 4 for the user U1 which receives the notification data, for example, a screen for displaying a message that the feature value is not stored is displayed. In addition, for example, a screen for providing a guide to select another database is displayed.

An available exemplary embodiment of the present invention is not limited to the above-described exemplary embodiment.

(1) For example, if a feature value whose degree of similarity to the feature value extracted from the “initial” feature-extraction target area is equal to or more than the above-described threshold TH is present in the database Y (YES in step S302), the controller 2a (notification unit) may immediately perform step S309.

(2) For example, if the number of updates ‘N’ is equal to the upper limit (YES in step S308), without performing step S309, the controller 2a may perform the storage routine again by using another database as the database Y.

(3) For example, after step S309, the controller 2a may associate the feature value extracted from the “initial” feature-extraction target area, the URL which has been input by the user U1, and the image with a marker generated in step S102 with each other, and may store them in another database. For example, in the case where, in the working information terminal 4 for the user U1 which receives the notification data, a screen for providing a guide to select another database is displayed, and where, as a result, the user U1 selects a second database, the controller 2a may associate these pieces of data and may store them in the second database selected by the user U1.

(4) For example, to reduce the processing load in step S306 (see FIG. 7A), the controller 2a may store a list (information) of feature values whose degrees of similarity to the feature value extracted from the feature-extraction target area in step S101 are equal to or more than the above-described threshold TH, in the main memory 2b (memory unit), for example, after step S303. In this case, the controller 2a (redetermination unit) may perform step S306 by using the feature values included in the above-described list one by one as a feature value Y, and may determine whether or not a feature value whose degree of similarity to the feature value extracted in step S305 is equal to or more than the threshold TH is present in the list, in step S307. If a feature value whose degree of similarity to the feature value extracted in step S305 is equal to or more than the above-described threshold TH is present in the list (YES in step S307), in order to reduce the processing load in step S306 performed in the next loop, the controller 2a may remove feature values whose degrees of similarity to the feature value extracted in step S305 are less than the threshold TH, from the list, for example, before step S308.

(5) As long as the “address information” is data indicating an address of an information resource such as content, the “address information” is not limited to a URL, and may be any information. For example, the “address information” may be a file path of an information resource.

(6) In the case where the server 2 is used by multiple companies, databases corresponding to the respective companies may be provided. In the case where multiple companies register information in the same database, information registered by a company other than an intended company may be retrieved in searching the database. In this regard, if databases are provided for the respective companies, occurrence of such a situation is suppressed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a feature extraction unit that extracts an extracted feature value indicating a characteristic of a target image, from a feature extraction area which has been set by a user; and
a storage unit that stores the extracted feature value extracted by the feature extraction unit in a database,
wherein the storage unit includes
a determination unit that calculates a degree of similarity to the extracted feature value extracted by the feature extraction unit, for each of feature values stored in the database, and that determines whether or not a feature value whose degree of similarity to the extracted feature value extracted by the feature extraction unit is equal to or more than a certain value is stored in the database,
a unit that stores the extracted feature value extracted by the feature extraction unit in the database when it is determined that a feature value whose degree of similarity to the extracted feature value extracted by the feature extraction unit is equal to or more than the certain value is not stored in the database, and
a notification unit that outputs predetermined notification information to the user without storing the extracted feature value extracted by the feature extraction unit in the database, when it is determined that a feature value whose degree of similarity to the extracted feature value extracted by the feature extraction unit is equal to or more than the certain value is stored in the database.

2. The information processing apparatus according to claim 1,
wherein the information processing apparatus is capable of communicating with a second information processing apparatus,
wherein the storage unit stores the extracted feature value extracted by the feature extraction unit and address information which has been input by the user, in the database in such a manner that the extracted feature value is associated with the address information when it is determined that a feature value whose degree of similarity to the extracted feature value extracted by the feature extraction unit is equal to or more than the certain value is not stored in the database, and
wherein the information processing apparatus further includes
an acquisition unit that acquires a search target image from the second information processing apparatus,
a unit that extracts a feature value indicating a characteristic of the search target image,
a search unit that searches for a feature value whose degree of similarity to the feature value extracted from the search target image is equal to or more than the certain value, from the feature values stored in the database, and
a transmitting unit that transmits address information associated with the feature value obtained through the search performed by the search unit, to the second information processing apparatus.

3. The information processing apparatus according to claim 1,
wherein the storage unit further includes
an update unit that updates the feature extraction area when it is determined that a feature value whose degree of similarity to the extracted feature value extracted by the feature extraction unit is equal to or more than the certain value is stored in the database,
a re-extraction unit that, when the feature extraction area is updated, extracts a re-extracted feature value indicating a characteristic of the target image, from the updated feature extraction area,
a redetermination unit that, when the re-extracted feature value is extracted by the re-extraction unit, determines whether or not a feature value whose degree of similarity to the re-extracted feature value extracted by the re-extraction unit is equal to or more than the certain value is stored in the database, and
a unit that stores the re-extracted feature value extracted by the re-extraction unit in the database when it is determined that a feature value whose degree of similarity to the re-extracted feature value extracted by the re-extraction unit is equal to or more than the certain value is not stored in the database, and
wherein the notification unit outputs the notification information when it is determined that a feature value whose degree of similarity to the re-extracted feature value extracted by the re-extraction unit is equal to or more than the certain value is stored in the database.

4. The information processing apparatus according to claim 2,
wherein the storage unit further includes
an update unit that updates the feature extraction area when it is determined that a feature value whose degree of similarity to the extracted feature value extracted by the feature extraction unit is equal to or more than the certain value is stored in the database,
a re-extraction unit that, when the feature extraction area is updated, extracts a re-extracted feature value indicating a characteristic of the target image, from the updated feature extraction area,
a redetermination unit that, when the re-extracted feature value is extracted by the re-extraction unit, determines whether or not a feature value whose degree of similarity to the re-extracted feature value extracted by the re-extraction unit is equal to or more than the certain value is stored in the database, and
a unit that stores the re-extracted feature value extracted by the re-extraction unit in the database when it is determined that a feature value whose degree of similarity to the re-extracted feature value extracted by the re-extraction unit is equal to or more than the certain value is not stored in the database, and
wherein the notification unit outputs the notification information when it is determined that a feature value whose degree of similarity to the re-extracted feature value extracted by the re-extraction unit is equal to or more than the certain value is stored in the database.

5. The information processing apparatus according to claim 3, further comprising:
a unit that stores, in a memory unit, information for specifying a feature value whose degree of similarity to the extracted feature value extracted by the feature extraction unit is equal to or more than the certain value,
wherein the redetermination unit determines whether or not a feature value whose degree of similarity to the re-extracted feature value extracted by the re-extraction unit is equal to or more than the certain value is stored in the database, in such a manner that determination as to whether or not a degree of similarity to the re-extracted feature value extracted by the re-extraction unit is equal to or more than the certain value is performed only for the feature value specified by the information stored in the memory unit.

6. The information processing apparatus according to claim 4, further comprising:
a unit that stores, in a memory unit, information for specifying a feature value whose degree of similarity to the extracted feature value extracted by the feature extraction unit is equal to or more than the certain value,
wherein the redetermination unit determines whether or not a feature value whose degree of similarity to the re-extracted feature value extracted by the re-extraction unit is equal to or more than the certain value is stored in the database, in such a manner that determination as to whether or not a degree of similarity to the re-extracted feature value extracted by the re-extraction unit is equal to or more than the certain value is performed only for the feature value specified by the information stored in the memory unit.

7. The information processing apparatus according to claim 3,
wherein the update unit updates the feature extraction area not only when it is determined that a feature value whose degree of similarity to the extracted feature value extracted by the feature extraction unit is equal to or more than the certain value is stored in the database, but also when it is determined that a feature value whose degree of similarity to the re-extracted feature value extracted by the re-extraction unit is equal to or more than the certain value is stored in the database,
wherein the update of the feature extraction area is repeatedly performed a finite number of times, and
wherein, in the case where it is determined that a feature value whose degree of similarity to the re-extracted feature value extracted by the re-extraction unit is equal to or more than the certain value is stored in the database, when the number of updates of the feature extraction area is less than the finite number, the notification unit does not output the notification information, and when the number of updates of the feature extraction area is equal. to the finite number, the notification unit outputs the notification information.

8. The information processing apparatus according to claim 4,
wherein the update unit updates the feature extraction area not only when it is determined that a feature value whose degree of similarity to the extracted feature value extracted by the feature extraction unit is equal to or more than the certain value is stored in the database, but also when it is determined that a feature value whose degree of similarity to the re-extracted feature value extracted by the re-extraction unit is equal to or more than the certain value is stored in the database,
wherein the update of the feature extraction area is repeatedly performed a finite number of times, and
wherein, in the case where it is determined that a feature value whose degree of similarity to the re-extracted feature value extracted by the re-extraction unit is equal to or more than the certain value is stored in the database, when the number of updates of the feature extraction area is less than the finite number, the notification unit does not output the notification information, and when the number of updates of the feature extraction area is equal to the finite number, the notification unit outputs the notification information.

9. The information processing apparatus according to claim 5,
wherein the update unit updates the feature extraction area not only when it is determined that a feature value whose degree of similarity to the extracted feature value extracted by the feature extraction unit is equal to or more than the certain value is stored in the database, but also when it is determined that a feature value whose degree of similarity to the re-extracted feature value extracted by the re-extraction unit is equal to or more than the certain value is stored in the database,
wherein the update of the feature extraction area is repeatedly performed a finite number of times, and
wherein, in the case where it is determined that a feature value whose degree of similarity to the re-extracted feature value extracted by the re-extraction unit is equal to or more than the certain value is stored in the database, when the number of updates of the feature extraction area is less than the finite number, the notification unit does not output the notification information, and when the number of updates of the feature extraction area is equal to the finite number, the notification unit outputs the notification information.

10. The information processing apparatus according to claim 6,
wherein the update unit updates the feature extraction area not only when it is determined that a feature value whose degree of similarity to the extracted feature value extracted by the feature extraction unit is equal to or more than the certain value is stored in the database, but also when it is determined that a feature value whose degree of similarity to the re-extracted feature value extracted by the re-extraction unit is equal to or more than the certain value is stored in the database,
wherein the update of the feature extraction area is repeatedly performed a finite number of times, and
wherein, in the case where it is determined that a feature value whose degree of similarity to the re-extracted feature value extracted by the re-extraction unit is equal to or more than the certain value is stored in the database, when the number of updates of the feature extraction area is less than the finite number, the notification unit does not output the notification information, and when the number of updates of the feature extraction area is equal to the finite number, the notification unit outputs the notification information.

11. The information processing apparatus according to claim 1,
wherein, when the notification information is output, the extracted feature value extracted by the feature extraction unit is stored in another database for storing a feature value extracted from an image.

12. An information processing apparatus comprising:
a feature extraction unit that extracts a feature value indicating a characteristic of a target image;
a registration accepting unit that accepts a first target image and an instruction for registration in a database;
a storage unit that associates a first feature value extracted by the feature extraction unit with a predetermined URL so as to store the first feature value extracted by the feature extraction unit and the predetermined URL in the database;
a search accepting unit that accepts a second target image and a search instruction; and
a search unit that compares a second feature value of the second target image extracted by the feature extraction unit with each of feature values registered in the database, and that, when it is determined that a similar feature value is registered in the database, transmits a reply including a URL associated with the similar feature value to an apparatus from which the search instruction has been transmitted,
wherein the storage unit includes
a determination unit that calculates a degree of similarity to the first feature value extracted by the feature extraction unit, for each of the feature values stored in the database, and that determines whether or not a feature value whose degree of similarity to the first feature value extracted by the feature extraction unit is equal to or more than a certain value is stored in the database,
a unit that stores the first feature value extracted by the feature extraction unit in the database when it is determined that a feature value whose degree of similarity to the first feature value extracted by the feature extraction unit is equal to or more than the certain value is not stored in the database, and
a notification unit that, when it is determined that a feature value whose degree of similarity to the first feature value extracted by the feature extraction unit is equal to or more than the certain value is stored in the database, does not store the first feature value extracted by the feature extraction unit in the database and that outputs predetermined notification information to a user.

13. A non-transitory computer readable medium storing a program causing a computer to execute a process comprising:
extracting an extracted feature value indicating a characteristic of a target image, from a feature extraction area which has been set by a user; and
storing the extracted feature value in a database,
wherein the storing of the extracted feature value includes
calculating a degree of similarity to the extracted feature value for each of feature values stored in the database, and determining whether or not a feature value whose degree of similarity to the extracted feature value is equal to or more than a certain value is stored in the database,
storing the extracted feature value in the database when it is determined that a feature value whose degree of similarity to the extracted feature value is equal to or more than the certain value is not stored in the database, and
outputting predetermined notification information to the user without storing the extracted feature value in the database, when it is determined that a feature value whose degree of similarity to the extracted feature value is equal to or more than the certain value is stored in the database.
